(19) United States
(12) Patent Application Publication
(10) Pub. No.: US 2010/0269658 A1
(43) Pub. Date: Oct. 28, 2010

(54) COPING JIG

(76) Inventor: Eldridge Weaver, Huntingtown, MD (US)

Correspondence Address: The Law Office of John T. Whelan, LLC, 2315 Hallowing Point Road, Prince Frederick, MD, 20678, US

(21) Appl. No.: 12/427,970

(22) Filed: Apr. 22, 2009

(51) Int. Cl. B26D 7/01

(52) U.S. Cl. 83/455

(57) ABSTRACT

A coping jig comprising a base and a guide secured to the base. The guide is configured to receive a work piece such as, for example, a metal pipe. A stop, such as, for example, a piece of metal, extends upward from the base and is positioned to be in contact with an end portion of the work piece when the work piece is received by the guide. When the work piece is received by the guide and an end portion thereof is in contact with the stop, the work piece may be coped, for example by a saw. Optionally, a retainer may be provided to removably secure the work piece to the guide.

### FIELD OF THE INVENTION

The present invention relates to mechanical device for coping pipe.

### BACKGROUND OF THE INVENTION

In the metal working industry, there exists a frequent need to cope pipe. Coping pipe generally means to join two sections of pipe by undercutting the end of one of them to the profile of the other so that the resulting joint resembles a miter joint. The joint is then often welded to ensure that the two pipe sections remain secured to one another. Applications requiring coped piping are numerous, and include the manufacture of hand railings, bicycle frames, race car frames and roll cages, gates and fences, and many more. Depending upon the application, it may be desirable to cope the pipe such that the resulting pipe sections form a “T”, that is, the sections are oriented at a 90 degree angle to one another. Alternatively, the pipe may be coped such that the resulting pipe sections are joined at another angle.

Metal pipe is generally available commercially in standard sizes. That is, most applications involve pipe having an inner diameter (“ID”) of ¾ inches, 1 inch, 1½ inches, 1¾ inches, or 2 inches. Various means are known to assist metal workers in coping such pipe. For example, Jancy Engineering of Davenport, Iowa, offers a “AL 100 tube coping machine,” which claims to be able to cope pipe having an ID of from ¾ inches to 4.5 inches. In operation, the Jancy AL 100 employs up to twenty-two mandrels (sold separately) which are selected by the operator according to the ID of the pipe being used. The device is not portable (it is about 5 feet in length) and thus can not be used on a job site, but rather only in a fixed location. Moreover, retail prices for the AL100 begin at $4,095.

Baileigh Industrial, Inc. of Manitowoc, Wis. offers similar products, including its RMD Model 800 and 900 eccentric cut tube and pipe notchers. These products are sizeable as well, and weigh almost 500 pounds. See, for example, in U.S. Pat. No. 6,435,783, which is incorporated herein by reference in its entirety.

Therefore, a need exists for a new and improved coping jig that is at least (i) more affordable that prior art models, (ii) portable, and (iii) does not require numerous accessories, such as mandrels, for use.

### SUMMARY OF THE INVENTION

In view of the foregoing disadvantages inherent in the known coping machines now present in the prior art, the present invention provides an coping jig and overcomes the above-mentioned disadvantages and drawbacks of the prior art. As such, the general purpose of the present invention, which will be described subsequently in greater detail, is to provide a new and improved coping jig and method which has all the advantages of the prior art, as set forth above, and includes novel features. In that respect, the present invention results in a novel and non-obvious coping jig that substantially departs from the prior art, and in doing so provides an apparatus that is more affordable that prior art models, is readily portable, and does not require numerous accessories, such as mandrels, for use.

According to one embodiment of the invention, a coping jig apparatus comprises a base and a guide secured to the base. The guide is configured to receive a work piece such as, for example, a metal pipe. A stop, such as, for example, a piece of metal, extends upward from the base and is positioned to be in contact with an end portion of the work piece when the work piece is received by the guide. When the work piece is received by the guide and an end portion thereof is in contact with the stop, the work piece may be coped, for example by a saw. Optionally, a retainer may he provided to removably secure the work piece to the guide.

According to a further embodiment, the guide portion is moveably secured to the base.

According to a further embodiment, the guide portion is fixedly secured to the base.

Other aspects and advantages of the invention are readily apparent from the following detailed description, illustrating a number of particular embodiments, including the best mode contemplated for carrying out the invention. The invention is also capable of further embodiments, and its details can be modified in various respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings, and in which like reference numerals refer to similar elements, and wherein:

FIG. 1 is a first perspective view of a coping jig of the present invention.

FIG. 2 is second perspective view of a coping jig of the present invention.

### DESCRIPTION OF THE PREFERRED EMBODIMENT

An improved apparatus for a coping jig is described. In the following description, for the purposes of explanation, numerous specific details are set forth in order to provide a thorough understanding of the present invention. It is apparent, however, to one skilled in the art that the present invention can be practiced without these specific details or with an equivalent arrangement.

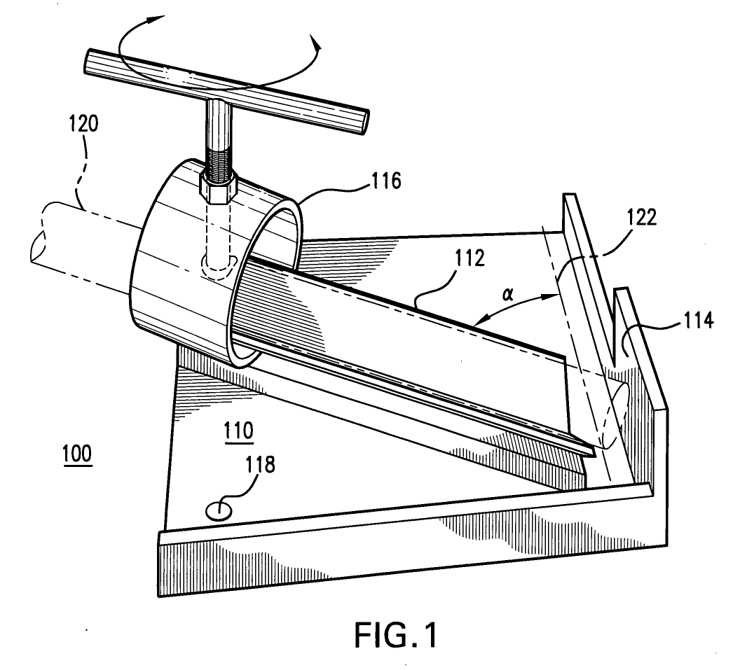

FIG. 1 illustrates a coping jig 100 in accordance with a first embodiment of the present invention. In this embodiment, and as described further below, coping jig 100 comprises a base 110, a guide 112, and a stop 114. Optionally, the invention may further comprise a retainer 116.

Base 110 is preferably made of a substantially flat rigid material, such as metal. The particular dimensions of base 110 are not critical, but base 110 should be large enough to adequately support various sizes of work pieces (not shown), while being small enough (and light enough) to be portable. Guide 112 is secured to an upper surface of base 110. Preferably, guide 112 is also made of a substantially rigid material such as metal. Guide 112 may be configured in any of a variety of configurations, such as, for example, a “V” shape, a trough, a semi-circle or the like, as will be apparent to those skilled in the art, such that a work piece to be coped may be positioned on or within guide 112. The work pieces may comprise, for example, a SS10, SS20, SS30, Schedule 40 and/or Schedule 80 metal pipe having an ID of, for example, ¾ inches, 1 inch, 1½ inches, 1¾ inches, or 2 inches.

Stop 114 is preferably made of a substantially rigid material, such as metal, and extends upward from the upper surface of base 110. Stop 114 is positioned proximate an end of guide 112 such that when a work piece is positioned on or within guide 112, an end of the work piece abuts stop 114. In this manner, stop 114 acts to prevent the work piece from extending farther than desired.

Optionally, a retainer 116 may be provided proximate the other end of guide 112. Retainer 116 may comprise, for example, a clamp, set-screw, or the like that acts to help retain the work piece on or within guide 112.

In operation, work piece is removably secured in position proximate a saw (not shown) by one or more vice clamps (also not shown). In this manner, the saw may be operated to cut an end portion of the work piece, as will now be described. More specifically, the work piece is positioned on or in guide 112 and advanced until an end of the work piece abuts stop 114. Optionally, the work piece may be removably,secured on or in guide 112 by retainer 116.

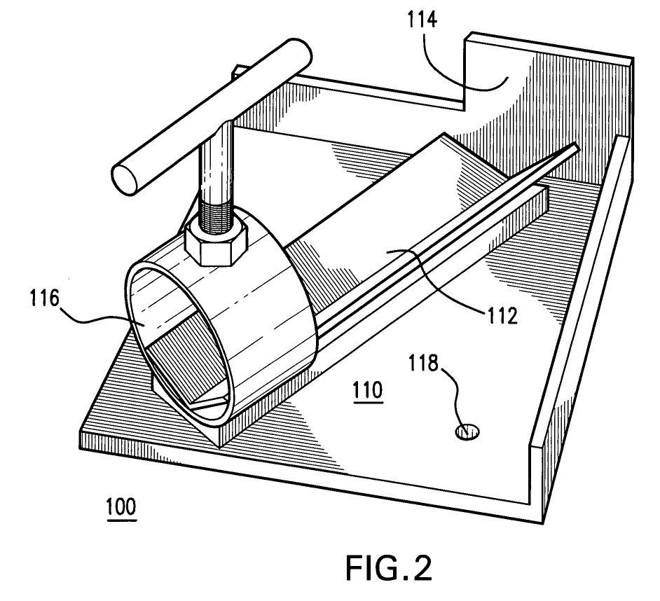

As shown in FIGS. 1 and 2, guide 112 is positioned at an angle to stop 114. In a preferred embodiment, the angle between guide 112 and stop 114 is between 30° and 33°. The saw, which may be any of a variety of known saws capable of cutting through the work piece, is positioned such that when the work piece is positioned on or in guide 112 and advanced until an end of the work piece abuts stop 114, a blade of the saw makes contact (when deployed) with the end portion of the work piece proximate stop 114. As the blade cuts through the work piece, the work piece is coped. Preferably, the coping comprises a two-step process, that is, first the work piece is cut as described above. Then, the work piece is rotated by 180° and the process is repeated. In this way, the work piece may be coped in a manner that is satisfactory for most commercial applications requiring a ninety degree (90°) angle between adjoining work pieces. Accordingly, the work piece coped in accordance with the above invention may be secured (by welding or the like) to a second work piece in a manner that is superior to that performed by coping jigs known in the art.

If two work pieces are to be adjoined at an angle other than 90°, i.e., “beveled coping”, then the above procedure may be modified accordingly. For example, instead of two cuts with the work piece turned by 180° between each cut, two or more cuts of the work piece may be made with the work piece turned by other angles therebetween to achieve the desired coping pattern. In this manner, beveled coping may be achieved, thus enabling joinder angles of between approximately 30° and 90°.

The foregoing, therefore, is considered as illustrative only of the principles of the embodiments of the invention. While the invention has been described above through a number of embodiments and implementations, the invention is not so limited, but rather covers various modifications and equivalent arrangements that may be apparent to one of skill in the respective art, all falling within the scope of the invention and within the scope of the appended claims. For example, coping jig 100 of the present invention may further comprise a mounting hole 118 disposed in base 100 by which coping jig 100 may be secured to the saw or other surface, as will be understood by those skilled in the art. Moreover, additional structure may also be added to secure the work piece at an angle of 90° to the cut of the saw blade, so as to permit the saw to perform a straight cut of the work piece, rather than coping.

What is claimed is:

1. A coping apparatus, comprising:
a base;
a guide secured to the base and configured to receive a work piece;
a stop extends upward from the base and is positioned to be in contact with an end portion of the work piece when the work piece is received by said guide;
wherein, when said work piece is received by the guide and an end portion thereof is in contact with the stop, the work piece may be coped, for example by a saw.

2. A coping apparatus according to claim 1, wherein said guide is fixedly secured to said base.

3. A coping apparatus according to claim 1, wherein said guide is removably secured to said base.

4. A coping apparatus according to claim 1, wherein said work piece is a metal pipe.

5. A coping apparatus according to claim 1, further comprising a work piece retainer.
